(19) United States
(12) Patent Application Publication
(10) Pub. No.: US 2026/0285423 A1
(43) Pub. Date: Sep. 24, 2026

(54) COUPLING A TRAILER TO A TRACTOR

(71) Applicant: ZF CV SYSTEMS GLOBAL GMBH, Bern (CH)

(72) Inventors: Timo ISERMANN, Wedemark (DE); Rüdiger MEYER, Hannover (DE)

(21) Appl. No.: 19/471,705

(22) PCT Filed: Apr. 2, 2024
(86) PCT No.: PCT/EP2024/058864

§ 371 Date: Oct. 2, 2025

(30) Foreign Application Priority Data
Apr. 6, 2023 (DE) 10 2023 108 940.4

(51) Int. Cl. B62D 53/08; B60Q 9/00

(52) U.S. Cl. CPC B62D 53/0871; B60Q 9/00

(57) ABSTRACT

The invention relates to a method (400) for assisting a process of coupling a tractor (105) to a trailer (110), comprising steps of measuring (410) a relative roll angle (210) between the tractor (105) and the trailer (110); and providing (420) a warning signal (308) if a value of the measured relative roll angle (210) exceeds a predetermined threshold (240).

### CROSS REFERENCE TO RELATED APPLICATIONS

This application is a U.S. National Phase application under 35 U.S.C. § 371 of International Application No. PCT/EP2024/058864, filed on Apr. 2, 2024, and claims benefit to German Patent Application No. DE 10 2023 108 940.4, filed on Apr. 6, 2023. The International Application was published in German on Oct. 10, 2024 as WO 2024/208794 A1 under PCT Article 21(2).

### FIELD

The present disclosure relates to a commercial vehicle comprising a tractor with a semitrailer. In particular, the present disclosure relates to the coupling of the semitrailer to the tractor.

### BACKGROUND

A commercial road trailer has, at its rear end, one or more axles with wheels and is designed at its front end to rest on and to be towed by a tractor. Such a trailer is also known as a semitrailer-trailer or a semitrailer. The tractor may also be called a semitrailer tractor. During a coupling operation, the semitrailer initially stands at the front on support legs. The tractor moves rearward under the semitrailer and raises the latter so that the support legs are relieved of load. The tractor can be coupled to the semitrailer and the support legs can be retracted.

In order to increase the efficiency of the tractor, automating a coupling operation between the tractor and the semitrailer is desirable. The two vehicles can be non-positively connected to each other. In addition, an electrical connection, a communication connection or a compressed air connection can be produced between the tractor and the semitrailer.

If the surface is uneven, the tractor and/or the semitrailer may have different lateral inclinations during the coupling operation, and therefore the production of one of the connections between the tractor and the semitrailer may be impeded.

WO 2022/077063 A1 relates to a technique for loading or unloading a vehicle trailer with loading ramps attached to the rear of the vehicle. In order to be able to drive another vehicle safely over the loading ramps, even on a steep surface, it is proposed to design the lengths of the loading ramps and a pitch angle and a rolling angle of the vehicle trailer to be controllable.

### SUMMARY

In an embodiment, the present disclosure provides a method for assisting a coupling operation of a tractor to a semitrailer. A relative rolling angle between the tractor and the semitrailer is detected. A warning signal is provided based on determining that an amount of the relative rolling angle exceeds a predetermined threshold value.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a vehicle system comprising a tractor and a semitrailer, according to an embodiment of the present disclosure;

FIG. 2 shows an exemplary relative position of a tractor relative to a semitrailer, according to an embodiment of the present disclosure;

FIG. 3 shows a control system, according to an embodiment of the present disclosure; and

FIG. 4 shows a flow diagram of a first method, according to an embodiment of the present disclosure.

### DETAILED DESCRIPTION

In accordance with an embodiment, the present disclosure provides an improved technique for carrying out a coupling operation between a semitrailer and a tractor.

According to a first aspect of the present disclosure, a method for assisting a coupling operation of a tractor to a semitrailer comprises the steps of detecting a relative rolling angle between the tractor and the semitrailer; and of providing a warning signal if an amount of the detected relative rolling angle exceeds a predetermined threshold value.

An absolute rolling angle of a vehicle is usually defined as the orientation of the vehicle about its longitudinal axis. A vertical, the direction of which corresponds to that of gravity, is used as reference. If the vehicle is standing upright, the absolute rolling angle is 0°.

A relative rolling angle between the tractor and the semitrailer relates to a deviation in orientations of the two vehicles about their rolling axes. In other words, the relative rolling angle can indicate how strongly one of the vehicles is twisted relative to the other about its longitudinal axis. The relative rolling angle can also be determined if the longitudinal axes of the vehicles do not intersect at a point or are offset from each other. The relative rolling angle can be measured directly between the vehicles. Alternatively, absolute rolling angles of the two vehicles can be determined and subtracted from each other. For example, if the tractor is inclined by +5° and the semitrailer by −5° relative to the vertical, the relative rolling angle can be 10°.

In this context, the coupling operation is the movement of the tractor toward the semitrailer, including the coupling, i.e., the non-positive connection of the two vehicles to each other. A fifth-wheel coupling can be attached to the tractor and a king pin to the semitrailer, and the coupling can comprise closing the fifth-wheel coupling with the king pin inserted.

It has been identified that the relative rolling angle between the vehicles may be decisive for a safe coupling operation, rather than the absolute rolling angle of one of the vehicles relative to a surface. In practice, for example, it may happen that the semitrailer is not standing vertically for a coupling operation, for example because, after the semitrailer has been parked, the surface has sunk unevenly due to rain or snow. Similarly, the tractor may be oriented differently from vertical during the coupling operation, for example due to an unevenness or a structural situation on the surface. In such cases, monitoring the relative rolling angle may contribute to safely carrying out a coupling operation.

The warning can be directed to an automatic control system for the coupling operation or to a person controlling the coupling operation. Within the scope of an automatic coupling operation, the warning signal can prevent a further approach of the vehicles or the coupling thereof. Similarly, raising of support legs of the semitrailer can be prevented. The warning can prevent one of the vehicles from being damaged during the coupling operation. In particular, it is possible to prevent an element of an automatic electric or pneumatic coupling between the vehicles from being damaged due to a lack of alignment between the tractor and the semitrailer. The relative rolling angle can be monitored selectively, periodically or continuously during a coupling operation.

In one embodiment, a non-positive coupling of the tractor to the semitrailer is released only if the amount of the detected relative rolling angle lies below the predetermined threshold value. In particular, a lock between the tractor and the semitrailer can be held in the open position. This can prevent the transmission of tractive forces between vehicles that are too greatly twisted in relation to each other about their longitudinal axes and may therefore be unstable. If the coupling is released, the tractive connection of the tractor to the semitrailer can be controlled manually or automatically.

The relative rolling angle can also be automatically reduced. This can take place in all cases or only if the amount of the rolling angle exceeds its associated threshold value. In some embodiments, the relative rolling angle is carried out continuously as a coupling operation proceeds. It can thus be taken into account that the tractor may change its absolute rolling angle as it approaches the semitrailer, for example as it moves over a bump or through a dip.

In some embodiments, the reduction in the relative rolling angle comprises one-sided raising and/or one-sided lowering of one of the vehicles on a left side or right side. This enables the vehicle concerned to be rotated about its longitudinal axis so that its absolute rolling angle is changed. In particular, the absolute rolling angle of one of the vehicles can be approximated to the rolling angle of the respective other vehicle in order to reduce the relative rolling angle. It is also possible to rotate both vehicles in opposite directions about their respective longitudinal axis. For this purpose, for example, the tractor can be raised on its left side and the semitrailer on its right side. In some embodiments, the amounts of both absolute rolling angles are minimized, rather than just the relative rolling angle. This allows the two vehicles to be better aligned both with each other and with the vertical.

In one embodiment, a left and a right support leg, which can be retracted or extended independently of each other, are attached to the semitrailer. The reduction in the relative rolling angle comprises retracting or extending one of the support legs.

In one embodiment, to control the rolling angle of the semitrailer, only one of its support legs may be retracted or extended, while the other is stationary. In another embodiment, the support legs can also be simultaneously retracted or extended in opposite directions. In both embodiments, the semitrailer can be set upright or its absolute rolling angle can be adjusted to an absolute rolling angle of the tractor.

The reduction in the amount of the relative rolling angle may also comprise inclining a coupling apparatus of the tractor about the longitudinal axis of the tractor. A fifth-wheel plate on which the front end of the semitrailer rests in the coupled state can be attached to the tractor. A coupling for the tractive connection of the tractor to the semitrailer can be arranged on the fifth-wheel plate, and therefore it may be referred to as a fifth-wheel coupling plate. The coupling apparatus can be controlled, for example, pneumatically or hydraulically in its orientation about the longitudinal axis of the tractor. The rolling angle of the tractor can refer to the fifth-wheel plate and the relative rolling angle can indicate a difference between the rolling angle of the fifth-wheel plate and the rolling angle of the semitrailer.

A deviation between the pitch angles of the semitrailer and the tractor is usually compensated for by a joint in the fifth-wheel coupling, in order also to compensate for the deviations occurring during travel, for example when driving through a dip. However, the height differences that have arisen due to the deviation in the pitch angles or are generally present during the coupling between the fifth-wheel coupling plate and the semitrailer are a problem and can lead to an air gap between the coupling apparatus of the tractor and the semitrailer and can thus cause the coupling operation to fail or can even lead to damage to the coupling apparatus. For this purpose, a relative height between the tractor and the semitrailer can optionally be additionally determined, wherein a warning signal can be output if the determined relative height lies outside a predetermined range. Due to the warning signal, an automatic coupling operation can be interrupted or broken off, as described herein with respect to an excessive rolling angle.

In some embodiments, the detected relative height can be automatically controlled in the predetermined range. For this purpose, a vehicle can be raised or lowered only at the rear or only at the front or both at the front and rear. In some embodiments, at least one of the vehicles is raised or lowered at an end closest to the other vehicle. In some embodiments, to compensate for the relative height, use can be made of the same actuators which can also be used to minimize the relative rolling angle. The tractor can be coupled to the semitrailer only if the relative height has also fallen below a predetermined amount.

In a further embodiment, adjusting the relative rolling angle and adjusting the relative height can also be carried out simultaneously. For example, if the semitrailer is intended to be rotated counter-clockwise along its longitudinal axis, the right support leg can be extended and/or the left support leg retracted. If the semitrailer is intended to be raised at the front, both support legs can be extended. Both maneuvers can be combined by the right support leg being extended and the left support leg being either stationary or also extended.

The relative height may refer to the coupling apparatus and relates to a mutual height deviation of the vehicles. The relative height may be zero if the top edge of the coupling apparatus lies exactly at the level of the bottom edge of the semitrailer. The range may extend upward and/or downward from said height.

A coupling operation can be safely carried out if the top edge of the coupling apparatus lies lower by a predetermined amount than the bottom edge of the semitrailer, so that the tractor can move under the semitrailer. However, a coupling operation can also be carried out if the top edge of the coupling device is several millimeters higher than the bottom edge of the semitrailer, before the tractor moves up to the semitrailer, so that the semitrailer can be easily raised by the reversing movement. In both cases, however, a predetermined distance from the relative height of zero should not be exceeded.

The disclosure can be implemented by means of a control system. According to another aspect of the present disclosure, a control system for assisting a coupling operation between a semitrailer and a tractor comprises a scanning device for determining a relative rolling angle between the tractor and the semitrailer; and a control apparatus for providing a warning signal if the amount of the relative rolling angle exceeds a predetermined threshold value.

The control apparatus may be designed to carry out a method described herein in whole or in part. For this purpose, the processing device may be electronic and comprise a programmable microcomputer or microcontroller, and the method may be in the form of a computer program product with program code means. The computer program product may also be stored on a computer-readable data carrier. Features or advantages of the method can be transferred to the apparatus or vice versa.

In one embodiment, the control system comprises an actuator for controlling a rolling angle of the tractor and/or of the semitrailer. In addition, an actuator can be provided for controlling a height of the tractor and/or of the semitrailer. The actuators can also be integrated with each other.

According to yet another aspect of the present disclosure, a vehicle comprises a control system described herein. In particular, the vehicle may comprise a tractor and/or a semitrailer.

Yet another aspect of the present disclosure relates to a vehicle system having a tractor and a semitrailer. The vehicle system, which may also be called a semi-truck, comprises a control system described herein. The control system can be designed to assist an automatic coupling operation of the semitrailer to the tractor. Components included by the control system can each alternatively be provided by the tractor and/or by the semitrailer.

The disclosure will now be described in more detail with reference to the accompanying figures.

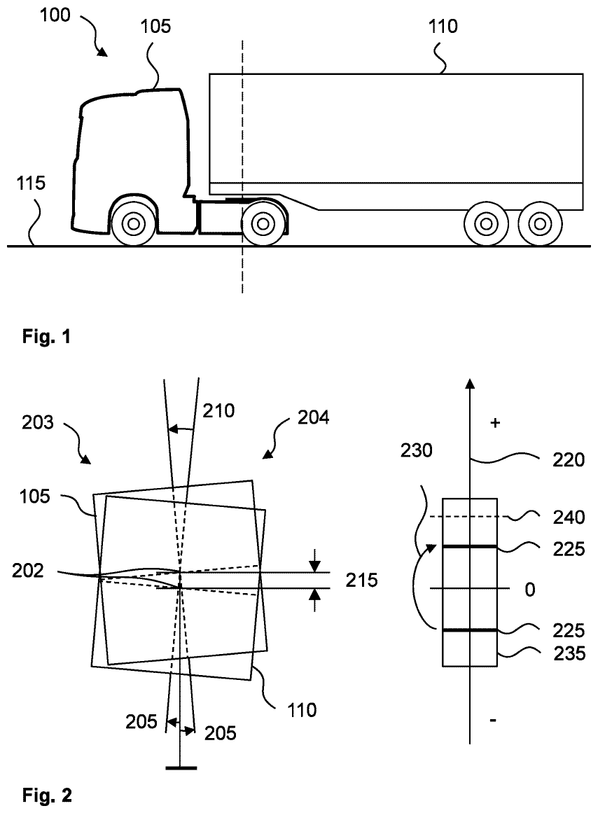

FIG. 1 shows a vehicle system 100 which comprises a tractor 105 and a semitrailer 110. The tractor 105 can be disconnected from the semitrailer 110, in order, for example, to be connected to another semitrailer 110. A vertical interrupted line indicates the location at which the vehicles 105, 110 can be disconnected from each other. Connecting the vehicles 105, 110 is referred to as coupling up or coupling, and disconnecting as decoupling.

During the coupling, the vehicles 105, 110 stand on a surface 115 which is ideally flat and horizontal, but in practise is inclined, uneven or has a differing degree of load-bearing capacity. A technique described herein relates to a coupling operation between the vehicles 105, 110 even under such difficult conditions. In this case, the tractor 105 is brought up to the semitrailer 110 until the vehicles 105, 110 can be coupled together.

FIG. 2 shows an exemplary relative position of a tractor 105 relative to a semitrailer 110. The view shown corresponds to a longitudinal section through the vehicle system 100 from FIG. 1 along a plane containing the interrupted line. The vehicles 105, 110 are each symbolized here as squares. Each square is halved both longitudinally and transversely by means of an interrupted line, with a longitudinal axis 202 of the associated vehicle 105, 110 in each case running through an intersection of the interrupted lines.

It can be seen that the squares representing the vehicles 105, 110 are each twisted by an absolute rolling angle 205 relative to a vertical. As a result, the vehicles 105, 110 are twisted in relation to each other about a relative rolling angle 210. The absolute rolling angles 205 are opposed to each other, with it being possible for the relative rolling angle 210 to be determined as a deviation of the absolute rolling angles 205. If the relative twisting is of sufficient strength so that an amount of the relative rolling angle 210 exceeds a predetermined threshold value, large forces which may put the stability of the vehicles 105, 110 at risk may occur during the coupling of the tractor 105 to the semitrailer 110.

Also shown in FIG. 2 is a relative height 215 between the tractor 105 and the semitrailer 110. The relative height 215 is shown here as the vertical distance of the longitudinal axes 202 of the vehicles 105 and 110. In order to drive the tractor 105 to the semitrailer 110, it can be ensured that the relative height 215 lies in a predetermined range, in which a relative height 215 of zero conventionally lies. The view is in the direction of travel of the vehicles 105, 110, so that a left side 203 is on the left and a right side 204 is on the right.

It should be noted that in practise the longitudinal axes 202 of the vehicles 105, 110 are rarely exactly aligned with each other, but enclose an angle with each other or are offset horizontally by a certain degree in relation to each other. The determination of the relative rolling angle 210 or of the relative height 215 in the region of a coupling apparatus between the tractor 105 and the semitrailer 110 can nevertheless be carried out in a manner described herein. Smaller disturbance variables or inconsistencies in the determination of the relative rolling angle or of the relative height may be ignored.

With regard to values and the comparison thereof, an illustration is given in the right-hand region of FIG. 2. A value 225 is determined on a predetermined scale 220. A value 225 lying above the line denoted by zero is positive, and a value 225 lying below it is negative. An amount 230 of a positive value 225 corresponds to the unchanged value 225; that of a negative value 225 corresponds to its value 225 multiplied by (−1).

A value 225 can be compared with a range 235. In this case, it can be determined whether the value 225 lies within or outside the range 235. Limits of the range 235 can be included in or excluded from the range 235. A value of 225 can also be compared with a threshold value 240. It is possible to determine whether the value 225 lies below, on or above the threshold value 240.

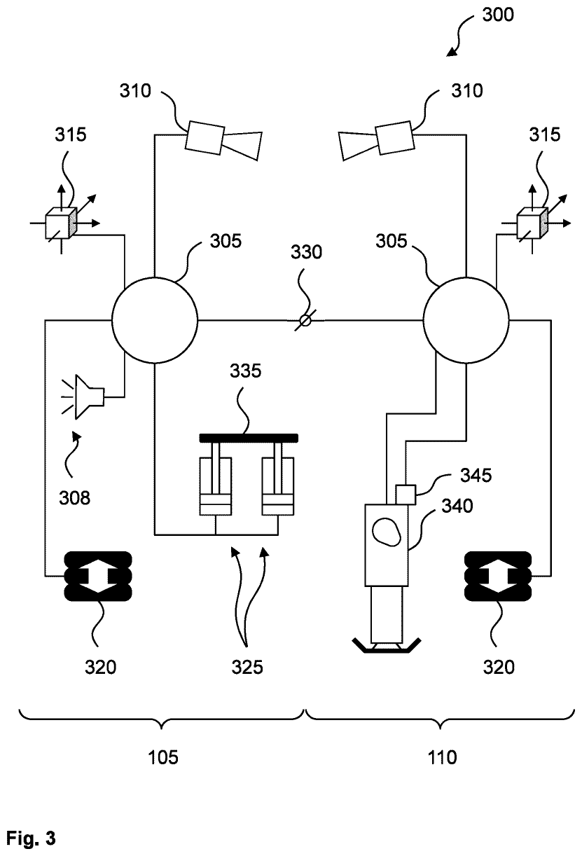

FIG. 3 shows an exemplary control system 300 for assisting an automatic coupling operation of a tractor 105 to a semitrailer 110. The illustrated control system 300 is designed by way of example substantially symmetrically by some components being provided both on the tractor 105 and on the semitrailer 110. However, it may also be sufficient to provide such a component in each case only on one side, i.e., only on the tractor 105 or only on the semitrailer 110. It should also be noted that some components, which provide the same function with respect to the technique proposed here for the tractor 105 and for the semitrailer 110, may be realized differently, as is described in more detail below.

In the embodiment shown, the control system 300 on the tractor 105 comprises a control apparatus 305, a first sensor 310, a second sensor 315, and a first actuator 320 and a second actuator 325. In some embodiments, only one sensor 310, 315 or only one actuator 320, 325 is provided. In some embodiments, an interface 330 may be provided for communication with a component on the semitrailer 110. The interface 330 can be wired or wireless.

The control apparatus 305 may comprise a conventional control unit with a processing device. The control apparatus 305 is optionally designed to carry out tasks other than those described herein. In some embodiments the control apparatus 305 may be connected to another component on board the tractor 105, to allow interaction with the other component or a person. In some additional embodiments, the control apparatus 305 is designed to output a warning signal 308. In one embodiment, the warning signal 308 can be output via an interface to a control unit or control system. In another embodiment, the warning signal 308 can be output to a person in the region of the vehicle system 100, in particular to a driver of the tractor 105.

The first sensor 310 may be fixedly attached to the tractor 105 and designed to scan the semitrailer 110. In some embodiments, the scanning may also take place contactlessly, for example by means of an ultrasonic sensor, a radar sensor or a LiDAR sensor. Optionally, a signal transmitter, a marking or a reflex element is attached to the semitrailer 110 in order to facilitate scanning by the first sensor 310. For example, a marking may consist of a retroreflective material. The first sensor 310 can determine a relative alignment of the semitrailer 110 with respect to the tractor 105. In some embodiments, the first sensor 310 is provided in the region of a coupling apparatus between the tractor 105 and the semitrailer 110.

The second sensor 315 may comprise an acceleration sensor, an inertial platform or a similar sensor, which is designed to determine an absolute rolling angle of the tractor 105 with respect to a field of gravity of the Earth. The second sensor 315 can optionally be sensitive about a plurality of axes and thus can also determine a pitch angle or a yaw angle of the tractor 105.

The first actuator 320 is designed to control a height of a rear end of the tractor 105. In some embodiments, two first actuators 320 are provided, which can be actuated independently of each other to raise or lower the rear end of the tractor 105 on the left or on the right in each case independently of the other side. Purely by way of example, the first actuator 320 is shown as bellows of a pneumatic chassis. Other realizations are also possible.

The second actuator 325 is designed to influence a height and/or a rolling angle of a coupling element for the semitrailer 110 on the tractor 105. The coupling element comprises, by way of example, a fifth-wheel plate 335, which is may be designed as a fifth-wheel coupling plate. The second actuator 325 comprises, by way of example, two pneumatic or hydraulic actuators, one of which is provided on the left side 203 and one on the right side 204 of the tractor 105. Other embodiments are also possible here.

In the embodiment shown, a control apparatus 305, a first sensor 310, a second sensor 315, and a first actuator 320 are provided on the semitrailer 110 in a manner corresponding to the tractor 105. Functions of these components are described with reference to the components on the tractor 105 and can be applied accordingly on the semitrailer 110.

Two support legs 340 can be provided on the semitrailer 110, one of which is mounted at the front left in the direction of travel and the other at the front right in the direction of travel. The support legs 340 are designed to support a load in a front region of the semitrailer 110 relative to the surface 115 when the semitrailer 110 is not resting at the front on the fifth-wheel plate 335 of the tractor 105. A support leg 340 can be retracted or extended, for example pneumatically, hydraulically or electromotively. In some embodiments, the left support leg 340 and the right support leg 340 may each be able to be retracted and extended independently of each other. In some additional embodiments, an associated load sensor 345 is provided on each of the support legs 340, said load sensor being designed to determine a load of the semitrailer 110, which acts on the support leg 340.

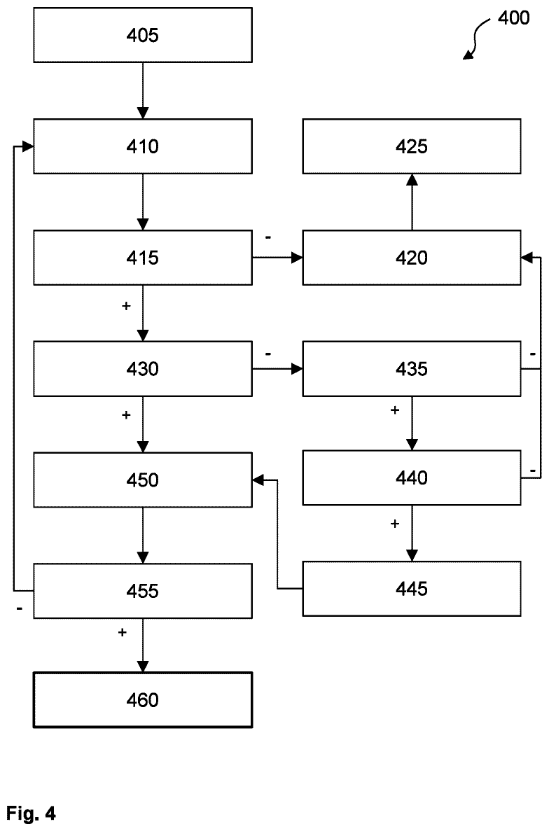

FIG. 4 shows a flow diagram of a method 400 for assisting a coupling operation between a tractor 105 and a semitrailer 110. In a step 405, a request for automatic coupling may be determined. At this time, the tractor 105 and the semitrailer 110 are not connected to each other and are located at a maneuvering distance, which can range from a few decimeters to a few meters, for example. In another embodiment, a manually controlled coupling operation can be started in this step.

In a step 410, a relative rolling angle 210 and/or a relative height 215 between the tractor 105 and the semitrailer 110 can be determined. In a step 415, it can be detected whether the relative height 215 lies within an adjustment range, which can be overcome by actuators 320, 325, 340.

If the relative height 215 exceeds the adjustment range, a warning can be provided in a step 420. The warning can be provided to a person carrying out the coupling operation or to a controlling system. Conditions for an automatic coupling operation can then be improved, for example by the surface 115 being filled or underlaid. Within the scope of an automatic coupling operation, in step 420, actuations of actuators 320, 325, 340 can be stopped. The method 400 may end unsuccessfully in a step 425, in which the tractor 105 and the semitrailer 110 are free and not coupled to each other.

If it is determined, in step 415, that the relative height lies within the adjustment range, it can be determined, in step 430, whether the determined relative rolling angle 210 is smaller than a predetermined tolerance. If this is not the case, it can be determined, in a step 435, whether a control system 300 is available for the relative rolling angle 210. Should no control system 300 be available, the method 400 can end via step 420 in step 425.

Otherwise, in a step 440, it can be determined whether the relative rolling angle 210 is smaller than a predetermined adjustment range of the control system 300. In this case too, the method 400 may end unsuccessfully via step 420 in step 425 if the relative rolling angle 210 exceeds the predetermined adjustment range. Otherwise, in a step 445, the relative rolling angle 210 can be adjusted by at least one of the actuators 320, 325, 340 being actuated in such a way that the relative rolling angle 210 is reduced.

In a step 450, it can be determined whether the relative height deviation 215 lies outside a predetermined range. In this case, the relative height deviation 215 can be minimized. This step may also be started immediately from step 430, if it was determined there that the relative rolling angle is smaller than the predetermined tolerance. In step 450, at least one of the actuators 320, 325, 340 can be activated in such a way that the height deviation in the predetermined range is controlled or approximated to a predetermined value 225 within the range.

In a step 455, it can be determined whether the relative height deviation 215 and/or the relative rolling angle 210 are satisfactorily approximated to respective specifications. If this is not the case, the method 400 can branch to step 410 and continue from there.

Otherwise, the method 400 may end in a step 460, in which the tractor 105 and the semitrailer 110 can be coupled to each other. For this purpose, a coupling apparatus can be released. In one embodiment, the coupling apparatus 335 can be automatically closed to tractively connect the tractor 105 to the semitrailer 110.

The tractor 105 can then be raised so that support legs 340 of the semitrailer can be relieved of load and retracted. The vehicle system 100 can therefore be ready for driving.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### Reference Signs (As Part of the Description)

100 Vehicle system
105 Tractor
110 Semitrailer
115 Surface
202 Longitudinal axis
203 Left side
204 Right side
205 Absolute rolling angle
210 Relative rolling angle
215 Relative height
220 Scale
225 Value
230 Amount
235 Range
240 Threshold value
300 Control system
305 Control apparatus
308 Warning signal
310 First sensor
315 Second sensor
320 First actuator
325 Second actuator
330 Interface
335 Fifth-wheel plate
340 Support leg
345 Load sensor
400 Method
405 Request for automatic coupling
410 Determine relative rolling angle and relative height
415 Relative height<adjustment range?
420 Stop
425 Tractor and semitrailer free
430 Relative rolling angle<tolerance?
435 Control system for relative rolling angle available?
440 Relative rolling angle<adjustment range?
445 Adjust relative rolling angle
450 Adjust height deviation
455 Finished?
460 Release or make coupling

1. A method for assisting a coupling operation of a tractor to a semitrailer, wherein the method comprises:
detecting a relative rolling angle between the tractor and the semitrailer; and
providing a warning signal based on determining that an amount of the relative rolling angle exceeds a predetermined threshold value.

2. The method as claimed in claim 1, wherein a non-positive coupling of the tractor to the semitrailer is released only based on determining that the amount of the relative rolling angle lies below the predetermined threshold value.

3. The method as claimed in claim 1, wherein the relative rolling angle is automatically reduced.

4. The method as claimed in claim 3, wherein the reduction in the relative rolling angle comprises one-sided raising and/or one-sided lowering of one of the tractor and the semitrailer on a left side or right side.

5. The method as claimed in claim 1, wherein a left and a right support leg, which can be retracted or extended independently of each other, are attached to the semitrailer, and wherein the reduction in the relative rolling angle comprises retracting or extending one of the left and right support legs.

6. The method as claimed in claim 4, wherein a coupling apparatus of the tractor is inclined about a longitudinal axis of the tractor.

7. The method as claimed in claim 1, wherein a relative height between the tractor and the semitrailer is determined, and wherein a warning signal is provided based on determining that the relative height lies outside a predetermined range.

8. The method as claimed in claim 7, wherein at least one of the tractor and the semitrailer is raised or lowered at an end closest to the other vehicle in order to control the relative height in the predetermined range.

9. The method as claimed in claim 8, wherein the relative height is approximated to a predetermined value within the predetermined range.

10. A control system for assisting a coupling operation between a semitrailer and a tractor, wherein the control system comprises:
a scanning device for determining a relative rolling angle between the tractor and the semitrailer; and
a control apparatus for providing a warning signal based on determining that an amount of the relative rolling angle exceeds a predetermined threshold value.

11. A vehicle comprising the control system as claimed in claim 10.

12. A vehicle system, comprising the tractor and the semitrailer and the control system as claimed in claim 10.
